(19) United States
(12) Patent Application Publication
(10) Pub. No.: US 2026/0283163 A1
(43) Pub. Date: Sep. 24, 2026

(54) LIQUID-SOURDOUGH MANUFACTURING INSTALLATION AND METHOD

(71) Applicant: Mauri Technology B.V., Etten-Leur (NL)

(72) Inventors: Rozália Borbála KENDERESI, Etten-Leur (NL); David Bernard Edmond LANSARD, Etten-Leur (NL); Steven NORCROSS, Manea (GB)

(73) Assignee: Mauri Technology B.V., Etten-Leur (NL)

(21) Appl. No.: 19/475,639

(22) PCT Filed: Apr. 18, 2024
(86) PCT No.: PCT/NL2024/050200

§ 371 Date: Oct. 15, 2025

(30) Foreign Application Priority Data
Apr. 18, 2023 (EP) 23168521.5

(51) Int. Cl. A21C 1/02; A21C 1/14; A21D 8/04; B01F 23/53; B01F 25/721; B01F 27/191; B01F 27/906; B01F 35/21; B01F 35/221; B01F 35/71; B01F 35/90; B01F 35/91; B01F 101/08

(52) U.S. Cl. CPC A21C 1/02; A21C 1/1435; A21C 1/145; A21D 8/045; B01F 23/53; B01F 25/721; B01F 27/191; B01F 27/906; B01F 35/2115; B01F 35/2132; B01F 35/2211; B01F 35/2215; B01F 35/7179; B01F 35/91; B01F 2035/99; B01F 2101/08

(57) ABSTRACT

The invention relates to a liquid-sourdough manufacturing installation (1), comprising
a flour hydration unit (2), comprising a flour hydration chamber (8);
a flour dosing system (3);
a water dosing system (4); and
a fermenter (5a, 5b, 5c);
wherein the flour hydration unit (2) comprises a flour feed inlet (7) into an upper part of the flour hydration chamber (8), the flour hydration chamber (8) comprising a water distributor (9), which water distributor (9) is configured to receive water from the water dosing system (4) and which water distributor (9) is arranged to distribute atomized water in the flour hydration chamber (8), the flour hydration chamber (8) further containing an agitator (10), the flour hydration chamber (8) further comprising an outlet (27) for dough formed in the hydration chamber (8);
wherein the outlet (27) for dough is connected with a dough inlet (13, 13a, 13b, 13c) of the fermenter (5, 5a, 5b, 5c) via a conduit (e) for feeding the dough from the flour hydration chamber to the fermenter; and
wherein the fermenter further comprises an outlet (15, 15a, 15b, 15c) for liquid sourdough.

The invention relates to an installation for the production of a liquid sourdough and to the use of said installation in the production of a liquid sourdough.

Keeping a natural and traditional leaven is a high maintenance process for the baker. It is necessary to carry out daily refreshments to maintain the quality of the sourdough. Changes in the substrate or the surroundings can lead to changes in the sourdough properties. Changes in the sourdough properties will naturally lead to changes in the finished baked product. In best case scenario these are flavour based and subtle, but often the sourdough changes in such a way as to negatively affect the dough handling and physical properties of the finished product, or it can lead to strong off-flavours in the sourdough.

Increasingly, around the world, legislation surrounding leaven (sourdough) is moving towards the French model, whereby bread labelled as “sourdough bread” must be made with an active leaven, with only minimal (0.2-0.5%) yeast addition permitted at the baking phase.

Therefore, a challenge in the field is to create a liquid sourdough that is clean label, of consistent quality and able to provide sufficient leavening ability (i.e. gassing power) throughout minimum three months of shelf life. Such a product can be used by a baker at any point in the shelf life to create baked goods of good consumer acceptance and the typical properties of taste, texture and colour associated with sourdough bakery products. Such product ideally must also be consistent in quality from batch to batch, always producing the same results when applied in the same recipes and methods by the baker.

It is further a challenge to provide an industrial-scale manufacturing installation that is also suitable for such a liquid sourdough.

WO2017/060165A1 describes a ready-to-use liquid baker's leaven (sourdough-type). A disadvantage of these known leavening mixtures is that they are sensitive to changes in substrate and surroundings, leading to changes in sourdough properties. These changes in sourdough properties can result in changes in flavour, which are often disadvantageous. A further disadvantage of the known leavening mixtures is that they have relatively short shelf lives. Further, the publication lacks detail on suitable equipment for the preparation of the leaven, e.g. equipment that can be upscaled to an industrial scale. For instance, in the Examples it is described that the liquid leavening agent is prepared by mixing water, wheat semolina and Lactobacillus strains plantarum strain and 107 cells of a Lactobacillus brevis strain, without details on how the mixing should be done. Specific provisions for temperature control are not described either. It is apparent that the described process has been performed in a lab without use of integrated or automated equipment wherein subsequent stages of an industrial production process can be done in an automated manner.

There is a need to provide a manufacturing installation that is also suitable for the production of a ready-to-use liquid sourdough, in particular an installation that is also suitable to produce a sourdough, preferably a clean-label sourdough, on an industrial scale. In particular, there is a need for such an installation that has at least one of the following advantages with respect to the produced dough: a less regular or no need for refreshment, a reduced batch-to-batch deviation in quality (more consistent batch to batch quality), a more consistent quality over the shelf-life, a high shelf-life (such as a shelf-life of at least 12 weeks, preferably of about up to about 16 weeks or even more).

The inventors have now found that it is possible to provide an installation that meets one or more of these needs, by providing specific provisions, such as a specific provision for preparing a fermentable dough upstream of a fermenter and an automated process control system.

Accordingly, the present invention relates to a liquid sourdough manufacturing installation (1), comprising
a flour hydration unit (2), comprising a flour hydration chamber (8);
a flour dosing system (3);
a water dosing system (4) (typically for warm water);
a fermenter (5a, 5b, 5c);
wherein the flour hydration unit (2) comprises a flour feed inlet (7) into an upper part, in particular the top, of the flour hydration chamber (8), the flour hydration chamber (8) comprising a water distributor (9) in an upper part of the flour hydration chamber, configured to receive water from the water dosing system (4) and arranged to distribute atomized water in the flour hydration chamber (8), the flour hydration chamber (8) further containing an agitator (10) arranged to blend the contents of the flour hydration chamber (8), the flour hydration chamber (8) further comprising an outlet (27) for dough formed in the hydration chamber;
wherein the outlet (27) for dough is connected with an inlet (13a, 13b, 13c) for dough inlet of the fermenter (5a, 5b, 5c) via a conduit for dough (e);
wherein the fermenter further comprises an outlet (15a, 15b, 15c) for liquid sourdough.

The invention in particular relates to a liquid-sourdough manufacturing installation according to any of the claims 1-15 of the application as filed. The manufacturing installation of the invention generally comprises an automated process control system (6). The process control system is arranged to control the operation of the installation; the process control system typically comprises a programable logic controller (PLC) adapted for supervisory control and data acquisition (SCADA). The PLC can amongst others be adapted for hydration chamber temperature (8) control; fermenter (5) temperature control; fermenter (5) pH monitoring; flour hydration chamber agitator (10) amps; fermenter stirrer amps; heat exchanger (16) temperature in/out control; heat exchanger (16) pressure in/out control; CIP/PIG control. Further it can be adapted for monitoring historical trending for critical process parameters.

The invention further relates to the use of the installation according to the invention for the production of a liquid sourdough, in particular a use according to any of claims 17-19 of the application as filed.

The invention further related to a method for the production of a liquid sourdough using an installation according to the invention, comprising hydrating cereal flour or a mixture comprising cereal flour and one or more other ingredients, such as a starter culture, in the flour hydration chamber under formation of the dough, feeding the dough via a conduit (e), typically using a pump, from the hydration chamber to the fermenter (the loading stage of the fermenter), subjecting the dough to fermentation in the fermenter (the fermentation stage of the fermenter) under formation of the liquid sourdough, and discharging the liquid sourdough from the fermenter (the discharge stage of the fermenter). The method for the production of liquid sourdough according to the invention in particular is a method according to any of the claims 20-34 of the application as filed.

The liquid sourdough manufacturing installation can be used for the preparation of any liquid sourdough. The installation is particularly advantageous for the production of liquid sourdough made from a leavening mixture comprising: cereal flour, preferably wheat flour; active malt flour; an active lactic acid producing starter bacterium; an active starter yeast; water; and—if desired—bran, such as wheat bran. Such liquid sourdough advantageously further comprises an inactive yeast, which is usually added before fermentation is completed. After fermentation is completed a further yeast may be included. In a particularly preferred embodiment, the installation is used for the production of a liquid sourdough from a specific novel mixture for the preparation of a liquid sourdough.

Accordingly, the invention further relates to a mixture for the preparation of a liquid sourdough, comprising cereal flower, preferably wheat flour; active malt flour; an inactive yeast; an active lactic acid producing starter bacterium; and at least one active starter yeast. Preferably, said mixture according to the invention further comprises cereal bran, more preferably wheat bran. The mixture typically is a fermentable dough, which upon fermentation forms the liquid sourdough.

The invention further provides a liquid sourdough made from the mixture for the preparation of a liquid sourdough according to the invention, in particular such liquid sourdough obtainable by a use or method according to the invention.

The mixture or liquid sourdough according to the invention preferably comprises
a lactic acid producing bacterium selected from the genera Lactobaccilus and Lactiplantibacillus, more preferably selected from the species L. brevis and L. plantarum; and
an active yeast selected from Lanchancea thermotolerans and S. cerevisiae, more preferably Lanchancea thermotolerans.

These microorganisms have been found to be particularly useful for obtaining a liquid sourdough with one or more advantages such as consistent quality from batch to batch, consistent quality over shelf-life, high shelf-life (in particular about 16 weeks or more). In particular, the inclusion of Lachancea thermotolerans as an active starter yeast in the liquid sourdough is found to contribute to improved properties, such as one or more improvements selected from: an increased number of colony forming units (CFU), a more stable pH, a more stable total titratable acidity (TTA), reduced batch-to-batch deviation, better baking performances and improved gassing power compared to leavening mixtures comprising other yeast strains as active starter yeasts.

Further details about advantageous sourdoughs and ingredients for their preparation in accordance with the invention will be described below, after a more detailed description of the installation according to the invention and its use.

### BRIEF DESCRIPTION OF THE FIGURES

These and other features, aspects, and advantages of the present disclosure will become better understood from the following description, appended claims, and accompanying Figures.

FIG. 1 schematically shows a flour hydration unit (2) of an installation according to the invention.

FIG. 2 schematically shows an installation/use/method according to the invention. Herein three fermenters in parallel are shown. The number of fermenters in the installation may be less (one or two) or more than three (typically 15 or less).

FIG. 3 schematically shows a fermenter (5) of an installation according to the invention.

Terminology used for describing particular embodiments is not intended to be limiting of the invention.

Terminology used herein is generally as commonly used in the art of preparing liquid sourdoughs, unless stated otherwise or unless it clearly follows otherwise from the context.

A “dough” is thus a mixture comprising flour (typically as a most abundant component based on weight) and water (in a sufficient amount to at least substantially hydrate the flour, and—if present—bran), which can be kneadable (without necessarily be free flowing under the influence of gravity) or can be liquid (free flowing under the influence of gravity). The dough fed into the fermenter to produce a sourdough in accordance with the invention can have a consistency that is about same as known doughs for the preparation of liquid sourdough. Such dough is typically is pumpable by a pump as generally known in the art.

As is used herein, the term “leavening agent”, refers to an ingredient that (in use) increases the volume and/or lightens the texture of a dough respectively a baked product. When mixed with a liquid, the leavening agent can form carbon dioxide gas bubbles, which cause a batter or dough to rise during (and sometimes before) the baking process. Examples of leavening agents include microbiological leavening agents, in particular (food-grade) CO₂-producing yeasts, like Saccharomycetaceae; (food-grade) CO₂-producing bacteria, like Lactobacilluceae. Further examples of leavening agents include chemical leavening agents, such as baking powder; baking soda; ammonium bicarbonate; potassium bicarbonate; potassium bitartrate; potassium carbonate; and monocalcium phosphate.

A leavening mixture is a mixture comprising a leavening agent, such mixture intended for leavening a dough, or intended a starting material for preparing a sourdough.

As is used herein, the term “sourdough”, refers to a fermented dough (also known as brew) fermented by lactic acid bacteria (LAB) and yeast, having a characteristic acidic flavour due to the lactic acid bacteria producing mainly lactic acid, acetic acid and some minor compounds and the typical flavour top-notes produced by the yeast. The presence of the microbiological leavening agent in the sourdough provides leavening of the dough. A sourdough comprises at least flour such as wheat and/or rye flour, water and an active microorganism such as a LAB and/or yeast. A sourdough may additionally comprise one or more further (conventionally used) ingredients, e.g. salt. A sourdough comprises a leavening agent intended for leavening a dough and as such is a “leavening mixture” per definition.

As is used herein, the term “active” for a microorganism, such as a bacterium or yeast, refers to a microorganism being capable of reproduction, metabolizing or colonization.

As is used herein, the term “inactive” for a microorganism, such as a bacterium or yeast, refers to a microorganism not being capable of reproduction, metabolizing or colonization.

As is used herein, the term “lactic acid producing bacterium”, refers to a general term for a bacterium that can produce lactic acid, at least when living. The term refers not only to lactic acid-producing bacteria belonging to the order Lactobacillus including genera such as Lactobacillus, Lactiplantibacillus, Weissella and Pediococcus, but includes other lactic acid producing bacteria, including Bifidobacterium belonging to the order Bifidobacteriales. Commonly used LAB in sourdoughs are L. brevis, L. buchneri, W. cibaria, L. fermentum, L. reuteri, L. sanfranciscensis, L. kefir, L. plantarum, L. pentosus, L. alimentarius, L. casei, L. paracasei, L. rhamnosus, P. acidilactici, P. pentosaceus, L. amylovorus, L. acidophilus, L. amylolyticus, L. delbreuckii and P. damnosus.

As is used herein, the term “starter” for an microorganism, refers to a microorganism, such as a yeast or bacterium, able to assist the beginning of a fermentation process in preparation of a dough, such as sourdough. General requirements for a microorganism to be suitable as a starter, include the ability to survive, metabolise and grow in a substrate, in this invention a substrate comprising flour and water, the absence of production of substances harmful to human health such as biogenic amines and toxins; the absence of resistance to antibiotics. A person skilled in the art may consult the “qualified presumption of safety (QPS)” requirements of the European Food Safety Authority (EFSA) as a guide for safety requirements of suitable starting microorganisms. A further requirements for a LAB to be suitable as a starter is the ability to produce organic acids (lactic and acetic primarily) and aroma compounds. A further requirements for a yeast to be suitable as a starter is the ability to produce carbon dioxide and thus ability to provide leavening power to sourdough.

As is used herein, the term “pH” refers to the apparent pH, i.e. the pH measured using a standard H+ electrode, at 20° C. The pH is measured by inserting a calibrated pH electrode in a medium, such as an aqueous fluid of which the pH is to be measured. For non-fluid media, such as bread, doughs and leavening mixtures in general (including liquid sourdoughs), a suitable amount of the medium is typically suspended in distilled water (typically 5 g or 10 g per 100 ml distilled water). As used herein, the pH of a leavening mixture, in particular a liquid sourdough, is the pH as measured by inserting a calibrated pH electrode in an aqueous suspension of 5 g of leavening mixture suspended in 100 ml of distilled water. The pH of a sourdough bread, as used herein, is the pH as measured by inserting a calibrated pH electrode in an aqueous suspension of 10 g of sourdough bread crumb suspended in 100 ml of distilled water.

As is used herein, the term “Total Titratable acidity (TTA)” refers to the amount (in ml) of a 0.1 M NaOH solution that is titrated until a pH of 8.5 is reached. The TTA of a leavening mixture can be measured by determining the amount of a 0.1 M NaOH solution that is added to an aqueous suspension of 5 g of leavening mixture suspended in 100 ml of distilled water until a pH of 8.5 is reached. The TTA of a sourdough bread can be measured by determining the amount of a 0.1 M NaOH solution that is added to an aqueous suspension of 10 g of crumb suspended in 100 ml of distilled water until a pH of 8.5 is reached. TTA is calculated by dividing 10 by the sample weight (g), and multiplying the obtained value by the NaOH content (ml).

As used herein, the singular forms “a”, “an” and “the” are intended to include the plural forms as well, unless the context clearly indicates otherwise. The term “or” is used to mean “and/or”, unless the context clearly indicates otherwise. The terms “or” respectively “and/or” include any and all combinations of one or more of the associated listed items. It will be understood that the terms “comprises” and/or “comprising” specify the presence of stated features but do not preclude the presence or addition of one or more other features. Any text or reference signs placed between parentheses shall not be construed as limiting, unless the context clearly indicates otherwise.

It will be understood that when a particular step of a method is referred to as subsequent to another step, it can directly follow said other step or one or more intermediate steps may be carried out before carrying out the particular step, unless specified otherwise.

As is used herein, the term “wt. %”, or “weight percentage”, or “percentage by weight”, generally refers to the mass fraction of a substance in a composition divided by the total mass of said composition, unless specified otherwise.

The term “(at least) substantial(ly)” is generally used herein to indicate that it has the general character or function of that which is specified. When referring to a quantifiable feature, this term is in particular used to indicate that it is at least 50%, more in particular more than 75%, even more in particular more than 90% of the maximum of that feature.

The term “(at least) essential(ly)” is generally used herein to indicate that it has the general character or function of that which is specified. When referring to a quantifiable feature, it generally includes a deviation of 15% or less from the given value, in particular a deviation of 10% or less, more in particular a deviation of 5% or less.

In the context of this application, the term “about” includes generally a deviation of 15% or less from the given value, in particular a deviation of 10% or less, more in particular a deviation of 5% or less.

The flour hydration unit (2) of the installation according to the invention comprises a flour hydration chamber (8). At least one feed inlet (7) for flour is provided in an upper part of the hydration chamber, typically at the top. In a use or method according to the invention this feed inlet can be used for the cereal flour only or for a mixture comprising the cereal flour and one or more of the further ingredients (in a dry form). The feed inlet (7) is arranged to receive cereal flour or (dry) mixture comprising cereal flour from the flour dosing system (3), which dosing system preferably comprises a loss-in-weight feeder. In use, ratio flour to water is usually determined on the basis of the flour batch and recipe. The flour hydration unit (2) is arranged for an automatic control, via the PLC system. Advantageously, water temperature of water dosed into the hydration chamber, water flow rate of water dosed into the hydration chamber and flour (mixture) mass flow rate into the hydration chamber are automatically controllable. Water temperature of water into the flour hydration chamber can in particular be adjustable, based on one or more of the following: temperature of the flour (mixture) to be fed into the flour hydration chamber, desired temperature of the dough to be prepared (e.g. in view of a desired temperature in the fermenter. An adjustable ratio of flour (mixture) mass flow rate to water flow rate is desirable for controlling consistency of the dough to be prepared.

The ratio flour (mixture) to water is usually kept essentially constant for a production session of a specific liquid sourdough (based on a specific recipe). Load control in the hydration system can be taken care of by a rotatable agitator inside the flour hydration chamber, a pump in the conduit (e) between flour hydration chamber and fermenter, or both.

The water dosing system (4) is generally configured for dosing water of an adjustable temperature. It typically comprises an inlet (a) connected to a hot water supply and an inlet (b) connected to a cold water supply and the water dosing system is configured to mix the hot water and cold water to water of an intermediate temperature (warm water) having a controlled temperature. The terms hot, cold and warm are used herein a relative to another, i.e. the hot water has the highest temperature, the cold water the lowest and the warm water a temperature in between the hot and the cold water. In view of efficient hydration and fermentation (e.g. in terms of energy efficiency, time needed to be effective), the warm water used in a method/use according to the invention introduced in the hydration chamber usually is in the range of about 20 to about 60 degrees C., preferably in the range of 25 to 50 degrees C. Accordingly, the water dosing system is usually arranged to provide warm water in said usual or preferred range. The cold water provision to which the cold water inlet is connected provides water having a lower temperature than the intended warm water temperature, generally a temperature between 0 and about 25 degrees C., in particular between about 5 and about 20 degrees C. The hot water provision to which the hot water inlet is connected provides water having a higher temperature than the intended warm water temperature, generally a temperature between about 30 and 100 degrees C., in particular between 35 and 80 degrees C., more in particular between 40 and 60 degrees C.

The adjustable water temperature is amongst other advantageous to allow a change of the warm water temperature atomised in the hydration chamber, dependent on the temperature of the flour (mixture) introduced into the hydration chamber. Dependent on the season/outdoor temperature, the temperature of the flour may somewhat vary in time; the flour can be relatively cold in Winter and relatively warm in Summer.

It is also possible that one or more further separate inlets are provided into the flour hydration chamber, usually also in an upper part, preferably at or near the top, for one or more further ingredients (not shown). The flour hydration chamber (8) further comprises a water distributor (9) in an upper part of the flour hydration chamber, configured to receive water from the water dosing system (4) and arranged to distribute atomized water in the flour hydration chamber (8). The water distribution system is typically also localised in an upper part of the hydration chamber, usually at a lower position that the flour feed inlet, although in principle it can also be located in the top, if the flour feed inlet is in the top. A lower location of the water dosing system is found to be advantageous for the hydration process. This allows the flour to cascade into a mist of water droplets (atomized water), whereby it is easier to control a desirable hydration to obtain a pumpable dough with advantageous consistency/viscosity and fermentability.

The water distributor (9) is arranged to spray water into the flow path between the flour feed inlet (7) and the pumpable dough outlet (27). Particularly preferred is a water distributor (9) comprising a plurality of spray nozzles (11) at or near the side wall (26) in the upper part of the flour hydration chamber, which spray nozzles (11) are arranged to spray the atomized water inward into the hydration chamber into the flow path between the flour feed inlet (7) and the pumpable dough outlet (27) in an at least substantially perpendicular direction to the flow path between the flour feed inlet (7) and the pumpable dough outlet (27). This distributor is in particular advantageous for obtaining a pumpable dough with desirable properties (such as consistency) for further processing (pumping to the fermenter, fermentation in the fermenter).

The water atomised into the flour hydration chamber can in principle contain an ingredient, other than the flour e.g. one or more of the starter-organisms, as long as the ingredient does not adversely affect atomization (e.g. due to too much viscosity increase).

The flour hydration chamber (8) further contains an agitator (10) arranged to blend the contents of the flour hydration chamber (8). Particularly suitable is an agitator (10) that extends at least substantially along the flour hydration chamber, the agitator comprising an essentially vertically positioned rotatable central shaft (25) and a plurality of arms (12) extending essentially perpendicular with respect to the shaft (25). Such an agitator contributes particularly to obtaining a pumpable dough with desired properties (such as consistency) for further processing. Such agitator can also be adapted for having a controllable rotation speed (by the PLC), thereby allowing to adapt the hydration process and/or mass flow rate through the hydration chamber.

The flour hydration chamber (8) further comprising an outlet (27) for dough formed in the hydration chamber. The outlet (27) for dough is connected with a dough inlet (13, 13a, 13b, 13c) of the fermenter (5a, 5b, 5c) via a conduit for pumpable dough (e). The conduit (e) generally is provided with a pump configure for pumping the dough from the hydration chamber to the fermenter. Such pumps are generally known in the art of processing (thick) viscous or pasty doughs and the like. The dough inlet (13, 13a, 13b, 13c) is generally positioned in the lower half of the fermenter, preferably at or near the bottom. This can avoid the occurrence of dead spots. Further it can avoid splashing (during filling of the fermenter).

The installation according to the invention comprises one or more fermenters. The fermenter can be based on a bioreactor known per se for processing of fermentable mixtures of water and cereal flour, further comprising at least a starter culture (i.e. fermentable doughs).

A plurality of fermenters, provided in parallel with respect to the hydration chamber (and further units for further downstream processing), is advantageous. Fermentation in a single fermenter usually takes place in an at least substantially batch-type manner (optionally fed-batch manner), and generally takes more time than hydration and down-stream processing (such as cooling, packing); i.e. fermentation is usually the bottle-neck in the use of the installation. With a single fermenter this will mean that the upstream processing unit(s), such as the hydration chamber (and down-stream processing unit(s) such as heat exchanger, packing unit) can be at rest for a substantial amount of time during use. The presence of at least two, preferably at least three, e.g. at least six fermenters allows simultaneous operation of different stages of the processing in the fermenters (loading stage, fermentation stage, withdrawal stage) in the installation, and better utilisation of other unit(s) of the installation. The number of fermenters in parallel is generally up to 15, preferably up to 12. Usually, a single hydration chamber suffices to supply each of the fermenters with dough. Usually, for the downstream processing (cooling, storing, packaging) a single (series of) downstream processing unit(s) is sufficient to further process the liquid sourdough from the fermenters. When the liquid sourdough comprising a plurality of fermenters (in parallel), these are usually configured to be operatable and controllable by the PLC, independently from each other. Herein, the PLC is typically adapted to allow the operation of the plurality of fermenters to be subsequently in a (i) fermenter loading stage, during which the pumpable dough is fed from the hydration chamber to the fermenter, (ii) a fermentation stage during which the dough in the fermenter is subjected to fermentation under formation of the liquid sourdough, and (iii) a fermenter discharge stage, during which the liquid sourdough is removed from the fermenter, and wherein whilst a first of said plurality of fermenters is in the fermentation stage a second of said plurality of fermenters is in the loading stage and a third of said fermenters is in the fermenter discharge stage.

The fermenter is usually thermostatted. It can then be operated at relative high temperature during fermentation and be cooled down already in fermenter if desired. Fermentation temperature can be based on fermentation conditions known per se, e.g. for a specific used micro-organism. Generally, the fermentation temperature is in the range of 20-50 degrees C., preferably 25-35° C., in particular 27-34° C., more in particular 28-32° C., e.g. about 30° C. Preferably, the fermentation takes place in a fermenter under essentially full batch conditions, i.e. wherein the dough to be fermented is essentially integrally introduced into the fermenter as a single batch

In a use/method according to the invention, the starter culture(s) and one or more other usual or preferred ingredients for the dough (in particular one or more substrates for a micro-organism for the sourdough, such as malt flour or cereal bran) are preferably fed into the fermenter as part of the dough; thus fermentation can take place through essentially the whole dough in the fermenter. It is also possible to add starter culture or another ingredient (such as a yeast to be added post-fermentatively) directly into the fermenter. Thus, in an embodiment the fermenter comprises a further inlet (14, 14a, 14b, 14c) for one or more further ingredients, such as yeast. When present, such inlet is preferably an inlet for a liquid preparation. Alternatively or in addition a provision can be present down-stream of the fermenter for adding one or more further ingredients, such as a yeast preparation, to the liquid sourdough that has been prepared in the fermenter (not shown in the figures). Such provision can e.g. be a mixing chamber provided in a conduit between fermenter and a heat exchanger (16) for cooling the liquid sourdough downstream of the fermenter. In a preferred embodiment, the installation comprises an active yeast inlet (14, 14a, 14b, 14c) in the fermenter or downstream thereof. It is advantageous to add additional active yeast, at or near the end of the fermentation, or thereafter, to provide additional gassing power during the shelf life of the liquid sourdough. Thus, in a preferred embodiment a provision is present to introduce such additional yeast. Preferably, the provision is suitable for introducing active yeast in compressed or dry form into the liquid sourdough, in a liquid form or in a cream form.

The outlet (15, 15a, 15b, 15c) for liquid sourdough (generally present at the bottom of the fermenter is usually connected to one or more units for down-stream processing of the liquid sourdough via a conduit (f, f1, f2, f3), which usually is provided with a pump (not shown). Typical down-stream processing units comprise a heat exchanger (16), a coolable storage (19), a packing unit (20).

The automated process control system (6) comprises a programable logic controller (PLC) adapted for supervisory control and data acquisition (SCADA). This system can be based on general knowledge about PLC and SCADA and the information disclosed herein.

Usually, the process control system (6) is adapted to control the temperature of water supplied to the water distributor (9), to control the flow rate of the water supplied to the water distributor (9) and to control the mass flow rate of flour supplied to the flour hydration chamber.

Advantageously, the fermenter (5, 5a, 5b, 5c) contains a temperature sensor for measuring the temperature of the fermenter contents and the automated process control system (6) is adapted for controlling the temperature of the fermenter contents. Advantageously the PLC contains a provision that, when out of a set temperature range, sets an alarm or that automatically makes adjustments to bring back the temperature in range. The adjustments can in particular comprise an adjustment of the water temperature of water fed into the hydration chamber. Further, the adjustment can comprise altering heat generation by a heating/cooling element of the fermenter (not shown).

Advantageously, the agitator in the flour hydration chamber is rotatable in an automatically controllable manner, making use of the PLC. An adjustable rotation speed can be used to manage the mass flow rate of the flour fed into the hydration chamber. Further, hydration rate of the flour in the hydration chamber can be influenced by altering the rotation speed; hydration rate can be increased by increasing the rotation speed. Thus, the controllable rotation speed of the agitator is also advantages in order to adapt processing dependent on changes in the nature of the flour.

In an embodiment, the fermenter (5, 5a, 5b, 5c) contains a pH sensor (29) for measuring the temperature of the fermenter contents and the automated process control system (6) is adapted for monitoring the pH of the fermenter contents.

Advantageously, the fermenter (5, 5a, 5b, 5c) contains a weight sensor (30) for measuring the weight of the fermenter contents and the automated process control system (6) is adapted for controlling the weight of the fermenter contents.

Advantageously, the fermenter (5, 5a, 5b, 5c) contains a stirrer (31) which is controlled by the automated process control system (6).

Generally, the liquid-sourdough manufacturing installation (1) according to the invention comprises a heat exchanger (16) for cooling liquid sourdough fed into the heat exchanger from the outlet (15, 15a, 15b, 15c) of the fermenter via a conduit (f1, f2, f3) for liquid sourdough. The heat-exchanger is arranged to reduce the temperature of the liquid sourdough (which generally has a temperature of about 60 degrees C. or less, in particular a temperature in the range of 20-50 degrees C., e.g. 30-40 degrees C.) to a storage temperature, generally in range of 0-10 degrees C., in particular about 2 to about 6 degrees C., such as about 4 degrees C. The heat-exchanger can make use of a chilled water/glycol cooling medium (17) or any known cooling medium suitable for cooling to the desired temperature. The heat-exchanger is usually adapted to allow rapid cooling of the liquid sourdough (typically within about 2 hours) to the storage temperature. The heat-exchanger allows the fermentation to be stopped in a controlled and consistent way, contributing to have a high shelf life. Particular advantageous is a plate heat exchanger or a tubular heat exchanger.

In a particularly preferred embodiment, the sourdough manufacturing installation of the invention further comprises an automatically controllable flow director (18), such as a 3-way valve, down-stream of the heat exchanger (16), the flow director comprising
an inlet for cooled liquid sourdough received from the heat exchanger (16) via a cooled liquid sourdough conduit (1);
a recycle stream outlet (22) for cooled liquid sourdough, connected with a recycle stream inlet (21a, 21b, 21c) into the fermenter via a recycle stream conduit (j, j1, j2, j3); and
a product stream outlet (23) for cooled liquid sourdough.

A discharge of the fermenter is usually carried out after completion of the fermentation stage in the fermenter. Accordingly, the recirculation loop is usually only operated after completion of the fermentation stage, although technically it is possible to operate the recirculation loop before completion of the fermentation stage.

The recycle facility (provided by the flow directer and recycle stream conduit) is advantageous because it can be used to return relatively cool liquid sourdough to the fermenter if the temperature in the fermenter is too high. Thus, advantageously the flow director (18) is controllable by the PLC based on an input signal of a temperature sensor inside the fermenter.

The recycle facility is further advantageous because it can be used to return liquid sourdough to the fermenter if the temperature of the cooled liquid sourdough downstream of the heat exchanger is too high for storage. Thus, advantageously the flow director (18) is controllable by the PLC based on an input signal of a temperature sensor present downstream of the heat exchanger (16), which may be between heat exchanger and flow director, in the flow director or between flow director and a storage unit (19). Thus, in a preferred embodiment,
the installation comprises a temperature sensor adapted for measuring the temperature of the cooled liquid sourdough, which sensor can be present at the outlet of the heat exchanger (16), at the inlet (24) of the flow director, in the flow director (18), down-stream of the flow director or in a conduit between heat exchanger (16) and the flow director (18), wherein the flow director, such as the 3-way valve, is controllable by the automated process control system (6), which process control system is adapted to adjust the flow rates of cooled liquid sourdough through product outlet (23) and through recycle outlet (22) on the basis of temperature data provided by said temperature sensor adapted for measuring the temperature of the cooled liquid sourdough.

Typically, when the flow director (18) is present, the process control system (6) and the flow director (18), in particular the 3-way valve, are adapted to close the product outlet (23) and to open the recycle outlet (22) if the temperature is above a set-point temperature, in particular a set-point temperature in the range of about 2 to about 6 degrees C., preferably about 4 degrees C.; further, the process control system (6) and the flow director (18) are in this preferred embodiment adapted to open the product outlet (23) and to close the recycle outlet (22) if the temperature is at or below said set-point temperature. It may also be used to recycle sourdough if the cooling down takes longer than desired, in particular longer than about 2 hours.

The installation according to the invention further usually comprises as a down-stream unit relative the fermenter (and down-stream of the heat exchanger and flow director, when present) a storage (19) unit, a packing unit (20) or both. In the figures, the storage unit is connected to the flow director (18) via a product stream conduit (k).

The packing unit (20) is adapted to package the liquid sourdough in packages for distribution to users (bakers) of the sourdough. Suitable packages include amongst others jerry cans and IBC′ containers.

Advantageously, the liquid-sourdough manufacturing installation (1) is a fully automated clean-in-place (CIP) installation. Advantageously, the liquid-sourdough manufacturing installation (1) is provided with a pipeline inspection gauge (PIG). CIP and PIG can be based on common general knowledge and the information disclosed herein.

In the use respectively method according to the invention, the production of the liquid sourdough, generally comprises the hydration of at least the cereal flour (and the cereal bran when used) in the flour hydration chamber under formation of a dough; feeding the dough, typically using pumping, to the fermenter; and subjecting the dough (which further comprises a suitable starter culture) to fermentation under formation of the liquid sourdough. The installation according to the invention is in particular advantageous to produce a liquid sourdough with respect to one or more of: highly consistent quality from batch to batch, a consistent quality over shelf-life, high shelf-life, more in particular when a mixture comprising the cereal flour, an active malt flour, an inactive yeast, an active lactic acid producing starter bacterium, an active starter yeast and—if desired—(cereal) bran are hydrated in the flour hydration chamber, preferably a flour hydration chamber containing an agitator having a rotatable vertical shaft (25) from which plurality of arms (12) extend in a perpendicular direction. Usually, in this type of agitator a plurality of layers with arms are arranged at different heights within the hydration chamber. It is also preferred in this embodiment that the water distributor comprising a plurality of spray nozzles (11) at or near the side wall (26) in the upper part of the flour hydration chamber, which spray nozzles (11) are arranged to spray the atomized water inward into the hydration chamber in an at least substantially perpendicular direction to the flow path between the flour feed inlet (7) and the pumpable dough outlet (27). A combination of said agitator with vertical shaft and extending arms and said water distributor is also in particular advantageous for essentially fully hydrating a mixture of the cereal flour and the bran to form a dough with good consistency for being pumped to the fermenter.

For the preparation of the sourdough usual ingredients for preparing a liquid sourdough may be used. Preferably, in addition to (cereal) flour, water, starter yeast and starter LAB, further use is made of one or more of the following: (cereal) bran, inactive yeast, active malt (flour) and active yeast. More preferably, use is made of each of cereal bran, active yeast, active malt flour and inactive yeast.

The amount of water can be a usual amount, based on amounts known for the preparation of liquid sourdough. The water content of the dough to be subjected to fermentation (fed to the fermenter) is usually in the range of about 40 to about 75 wt. %, in particular in the range of about 40 to about 70 wt. %. A relatively high water content results in a relatively low viscosity, which facilitates pumping of the dough from the hydration chamber to the fermenter. A relatively low water content is advantageous for the production of a concentrated liquid sourdough. In a first advantageous embodiment, the water content of the dough to be subjected to fermentation for the production of the liquid sourdough is in the range of about 60 to about 75 wt. %, more preferably in the range of 60-70 wt. %. In a second advantageous embodiment, the water content of the dough to be subjected to fermentation is in the range of about 40 to about 60 wt. %, in particular in the range of 45 wt. % to 55 wt. %, more in particular in the range of 49 wt. % and 51 wt. %, e.g. about 50 wt. %.

The flour in the mixture for the preparation of a liquid sourdough in accordance with the invention typically comprises one or more cereal flours. The cereal flour preferably comprises cereal flour selected from wheat flour and rye flour. Cereal flour is a powder derived from the milling, grinding and sifting of a cereal grain. It is a substrate for fermentation.

Usually, the cereal flour content of the dough to be subjected to fermentation (fed to the fermenter) is at least about 20 wt. %, preferably at least 22 wt. %, more preferably at least 24 wt. %, in particular at least 27 wt. %. Usually, the cereal flour content of the dough to be subjected to fermentation (fed to the fermenter) is about 45 wt. % or less.

In a first advantageous embodiment (wherein the water content is in the range of about 60 to about 75 wt. %, in particular in a range of about 60 to about 70 wt. %), the cereal flour content of the dough to be subjected to fermentation is about 20 wt. % to about 37 wt. %, preferably about 22 wt. % to about 35 wt. %, in particular about 23 wt. % to about 30 wt. % or 24 wt. % to 29 wt. %.

In a second advantageous embodiment (wherein the water content is in a range of about 40 to about 60 wt. %), the cereal flour content in a leavening mixture according to the invention is between 37 wt. % and 45 wt. %, more preferably between 39 wt. % and 43 wt. %, more preferably between 40.2 wt. % and 41.8 wt. %, such as about 41 wt. % of the leavening mixture.

The cereal flour preferably comprises 50-100 wt. % of wheat flour, more preferably at least 60 wt. % of wheat flour, more preferably at least 70 wt. % of wheat flour, more preferably at least 80% of wheat flour, most preferably at least 90% of wheat flour. The cereal flour may comprise rye flour such as for example 10-100 wt. %, at least 20 wt. %, at least 30 wt. %, at least 40 wt. %, at least 50 wt. %, at least 60 wt. %, at least 70 wt. %, at least 80 wt. %, at least 90 wt. % of rye flour. Usually, in particular when used in combination with wheat flour, the rye flour content is up to 50%, up to 40%, up to 30 wt. %, up to 20 wt. % or up to 10 wt. %.

Advantageously cereal bran is present in the mixture for the preparation of a liquid sourdough in accordance with the invention, preferably wheat bran. The bran serves as a substrate for fermentation. When present, the amount of bran usually is at least about 1 wt. % of the dough to be subjected to fermentation (fed to the fermenter), preferably at least 1.5 wt. The amount of bran usually is in the range of from 0 to about 3 wt. % of the dough to be subjected to fermentation (fed to the fermenter), preferably up to 2.5 wt. %, in particular up to about 2.25 or up to about 2.0 wt. %.

The bran is usually also hydrated with the flour in the flour hydration unit. Cereal bran is the remainder of cereal grains from which the endosperm portion has been removed, or the residue from which the attached endosperm or germ has been further removed in the process of producing cereal flour, such as wheat flour. Cereal bran typically essentially consists of the hard outer layers of the grain. The hard outer layers are typically at least substantially composed of the aleurone, the pericarp and (if present) the pedicel. The bran increases buffering capacity for a higher end total titratable acidity (TTA) of the sourdough.

In principle any starter cultures and other ingredients known in the art for the production of a liquid sourdough can be used. In particular as a CO₂ producing yeast (active starter yeast), a yeast from the Saccharomyces can be used, preferably selected from the group of Saccharomyces, Lanchancea, Kazachstania, Wickerhanomyces, Torulaspora, Pichia and Candida yeasts. Of these an active starter yeast selected from the group consisting of Lachancea thermotolerans, Kazachstania humilis, Wickerhanomyces anomalus, Torulaspora delbreuckii, Pichia kudriavzevii, Candida glabrata and Saccharomyces cerevisiae are particularly suitable. In particular, in accordance with the invention, good results are achieved with a Saccharomyces or Lanchancea yeast.

The active yeast starter content can be based on known methods for the preparation of liquid sourdough. The active yeast starter content, in particular the active starter Lachancea thermotolerans content used in the dough for preparing the liquid sourdough usually is at least 0.0005 wt. %, preferably at least about 0.001 wt. %, in particular at least 0.005 wt. %, or at least 0.01 wt. %. The active starter yeast content generally is 2 wt. % or less, in particular 1 wt. % or less, more in particular 0.5 wt. % or less. Good results have also been achieved with an active starter yeast content of about 0.1 wt. % or less, e.g. 0.05 wt. % or less. Advantageously, the active starter yeast content is about 50 wt. % to about 100 wt. % of the LAB starter content; amongst others, good results have been achieved wherein active starter yeast and LAB starter are used in about the same amounts by weight. In a specifically preferred embodiment, in particular an embodiment comprising 60 wt. % or more water, the active starter yeast content used in the dough for preparing the liquid sourdough is advantageously in the range of 0.0005-1 wt. %, more preferably in the range of about 0.001 to 0.5 wt. %, in particular up to 0.1 wt. % or up to 0.005 wt. %. In a further specific embodiment, in particular an embodiment wherein the dough has a water content of 60 wt. % or less, the active yeast starter content is between 0.001 wt. % and 0.05 wt. %, in particular between 0.01 wt. % and 0.05 wt. %, more in particular between 0.01 wt. % and 0.05 wt. % or between 0.015% and 0.025 wt. %, such as about 0.02 wt. %.

In particular, a lactic acid bacterium as mentioned herein above can be used as a starter lactic acid bacterium, preferably a lactic acid bacterium selected from L. brevis, L. buchneri, W. cibaria, L. fermentum, L. reuteri, L. sanfranciscensis, L. kefir, L. plantarum, L. pentosus, L. alimentarius, L. casei, L. paracasei, L. rhamnosus, P. acidilactici, P. pentosaceus, L. amylovorus, L. acidophilus, L. amylolyticus, L. delbreuckii and P. damnosus. It is particularly preferred, for achieving an advantage selected from: a highly consistent quality from batch to batch, a consistent quality over shelf-life, a high shelf-life to use a lactic acid producing starter bacterium selected from the genera Lactobacillus and Lactiplantibacillus. In view of such advantage it is also preferred that an active starter yeast selected from Lanchancea thermotolerans and S. cerevisiae is used in the fermentation.

The starter lactic acid bacterium content can be based on known methods for the preparation of liquid sourdough. The LAB starter content in the dough to be subjected to fermentation (fed to the fermenter)—in particular the Lactobaccilus, Lactiplantibacillus or Lactobaccilus+Lactiplantibacillus starter content, more in particular the L. brevis, L. plantarum or Lactobaccilus+Lactiplantibacillus starter content can be chosen in a wide range, usually in the range of about 0.0005 to about 5 wt. %, preferably in the range of about 0.001 to about 5 wt. %, in particular in the range of about 0.05 to about 5 wt. %, more in particular in the range of 0.1-5 wt. % or in the range of 0.2-4.8 wt. %. In a first advantageous embodiment, in particular for dough for preparing a liquid sourdough having a water content in the range of about with 60 to about 75 wt. %, the LAB starter content is typically relatively low, typically in the range of 0.0005-3.5 wt. %, preferably in the range of about 0.001 to about 2 wt. %, in the range of 0.1-2 wt. %, or in the range of 0.1-1 wt. %. for a dough to prepare a liquid sourdough having a water content of less than 60 wt. %, it may also be advantageous to have a lactic acid bacteria content of 0.0005-3.5 wt. %, advantageously in the range of about 0.001 wt. % to about 2 wt. %, in the range of 0.1-2 wt. %, or in the range of 0.1-1 wt. %. However, also good results have been achieved with a such a liquid sourdough having a lactic acid content of more than 3.5 wt. %, such as in the range of between 4 wt. % and 5 wt. %, more preferably between 4.2 wt. % and 4.8 wt. %, more preferably between 4.4% and 4.6 wt. %, such as about 4.5 wt. % of the leavening mixture.

Inactive yeast can be included in a mixture in accordance with the invention. It can be added for contributing to a relaxing effect on the dough through interactions with the gluten network (Meerts et al., 2018. Journal of Cereal Science 82:183-189). In accordance with the invention it can also be added as a liquid. Typically, it is added before introduction into the fermenter or in an initial stage of fermentation. Addition of the inactive yeast can be as part of the flour when introduced in the flour hydration chamber (e.g. when in dry from) or introduced via a separate inlet in the flour hydration chamber, e.g. as a liquid as part of the water used for hydration of the flour (introduced via the water dosing system). Including the inactive yeast in the flour hydration chamber can thus simplify the preparation process. Further it has been found that this is advantageous when preparing liquid sourdough. In liquid sourdough production, the “relaxing” effect of the inactive yeast has the benefit of allowing better mixing of the substrate-when the flour and water is mixed for too long before adding starters, the act of mixing can cause strands of gluten to form, which negatively effects the consistency of the product. It was found by the inventors that the use of inactive yeast in a liquid leavening mixture according to the invention is for the benefit of the micro-organisms used for the preparation of the sourdough, and to increase the total acids present in the sourdough without causing a decrease in the pH to levels that are toxic to the microbes. The increase in acidity is relevant, when aiming to prepare a bread with the liquid sourdough having a relatively low pH, such as a maximum pH of 4.3 (measured in the crumb) and/or a relatively high acetic acid concentration (such as of 900 ppm or more. The inactive yeast has an effect on the buffering capacity of the sourdough—this is the amount of acid or base that can be added to a volume of solution before its pH changes significantly. Inactive yeasts are also known to be good sources of nutrients such as proteins, peptides, amino acids, polysaccharides, vitamins, and minerals; to be containing about 45-55% of protein and to be rich in glutamic acid (Pozo-Bayón et al., 2009. Food Research International 42:754-761; Toh and Liu, 2017. AMB Express 7:156-156).

When used, the inactive yeast content in dough to be subjected to fermentation (to be fed to the fermenter) usually is at least about 0.5 wt. % in particular at least about 1 wt. %. The inactive yeast content in dough to be subjected to fermentation (to be fed to the fermenter) usually is about 3 wt. % or less, preferably in the range of 1.5 wt. % to 2.5 wt. %, more preferably in the range of 1.75 wt. % to 2.25 wt. %, such as about 2 wt. %. In a specifically preferred embodiment, wherein the dough comprises at least 60 wt. % water, the inactive yeast content is advantageously in the range of 1.5-2.25 wt. %.

Malt flour is a dried powdered product usually made from germinated cereal. Barley is the most commonly malted grain, in part due to its high diastatic power or enzymatic content. The term “active malt (flour)”, refers to a malt (flour) that comprises an enzyme having amylase activity, such as alpha-amylase activity and/or beta-amylase activity. Active malt (flour) breaks starches in (cereal) flour down to smaller sugars. These smaller sugars are more bioavailable to the LAB and active yeast added to the sourdough, which leads to a more efficient fermentation of the substrate. It was found that less residual sugars were left in the sourdough after processing was finished when using a leavening mixture comprising malt flour, resulting in a product with a more stable shelf life compared to a sourdough without malt flour. Without being bound by theory, with less residual sugars for the LAB and yeast to ferment, the LAB and yeast aren't converting the sugar into more harmful substances (i.e. harmful for the bacteria and yeasts) like acids and carbon dioxide, leading to more stability over shelf life in the product. Usually, the active malt (flour) is selected from the group consisting of active barley malt (flour), active wheat malt (flour), active rye malt (flour), active corn malt (flour) and active rice malt (flour). Preferably, the active malt (flour) is a malted wheat (flour).

When present, the active malt content of the dough to be subjected to fermentation (fed to the fermenter) usually is at least 0.05 wt. %. The active malt content in said dough usually is 2 wt. % or less. Preferably, the active malt content in said dough is in the range of 0.1 wt. % to 1 wt. %, more preferably in the range of 0.1 wt. % to 0.4 wt. %, in particular in the range of 0.15% to 0.30 wt. %, e.g. about 0.2 wt. %. In a specifically preferred embodiment, wherein the dough for preparing liquid sourdough comprises at least 60 wt. % water, the active malt content in the leavening mixture according to the invention is advantageously in the range of 0.15-0.225 wt. % of the leavening mixture.

In an advantageous embodiment, the fermentable dough for preparing the liquid sourdough comprises a further ingredient, which is a fermentable sugar. Particularly suitable are fermentable hexoses, such as fructose or glucose. In particular good results have been achieved with fructose. The fermentable sugar is a substrate for the lactic acid bacteria contributing to growth of the lactic acid bacteria and/or production of organic acid, in particular acetic acid. The presence of the fermentable sugar is in particular advantageous in an embodiment with a relatively high water content, such as of at least 60 wt. % and/or a relatively low lactic acid bacteria content when starting to prepare the liquid sourdough. It has been found to have a positive effect on yield.

If added, the fermentable sugar is usually added in a concentration of up to about 5%; in particular—if present—the content of the added fermentable sugar preferably is in the range of 0.5-5 wt. % of the dough used for the preparation of the liquid sourdough.

As mentioned above, preferably, at or close to the end of the fermentation (e.g. after at least 80%, at least 90% or at least 95% of the residence time in the fermenter has lapsed), additional (active) yeast, in particular S. cerevisiae, is added. Such yeast is also called pitch yeast. Preferably this is added in compressed, dry or cream form, more preferably in compressed or dry form, most preferably in compressed form. The amount of said additionally added yeast preferably is at least about 2 wt. %. Usually the amount of said additionally added yeast less 10 wt. % or less. In a specifically preferred embodiment said amount of additionally added yeast is in the range or 3-7 wt. %, in particular about 5 wt. % on total weight of the mixture.

Methods to determine stability of a sourdough over shelf life Stability over shelf life is a very important property of liquid sourdough formulations. The end user (mostly a baker) can receive and use a product at any point over its shelf like, which usually should be at least 12 weeks, in particular 12-16 week, and the product should perform essentially the same regardless of the point in time it is used (within reason). This means that the acidity should not change dramatically, and the LAB and active yeast need to have a sufficient viability throughout shelf life-particularly the yeast as they provide the leavening power of the sourdough.

Cell counts of lactic acid bacteria (LAB) and yeast cell counts can be determined using methods known to a skilled person such as for example by plating serial dilution of sourdough samples on an agar plate such as a Man Rogosa Sharpe (MRS) plate with cycloheximide and a Yeast extract Peptone Dextrose (YPD) agar plate with chloramphenicol for the determination of LAB and yeast cell counts respectively.

Organic acids and sugars may be quantified by performing high performance liquid chromatography (HPLC). For example, a suspension of 2 g of leavening mixture in 20 mL of Milli-Q water may be prepared, shaken and thereafter centrifuged at 4000 rpm for 15 min. Hereafter, the supernatants may be filtered directly in a HPLC vial for quantification by HPLC e.g. by using an Agilent Hi-Plex H (4.7×300 mm) HPLC column according to the manufacturer's instructions. To quantify organic acids in sourdough bread, 0.20 g of bread crumb may be mixed with 100 ml of water, homogenized and centrifuged at 5000 rpm for 15 min. Hereafter, the supernatants may be filtered directly in a HPLC vial for quantification by HPLC e.g. by using an Agilent Hi-Plex H (4.7×300 mm) HPLC column according to the manufacturer's instructions. Organic acids can be detected with a variable wavelength detector (VWD) at 210 nm and sugars can be detected with a refractive index (RID) detector. The organic acid content, e.g. acetic acid and lactic acid content, can be expressed in mg/kg or ppm, which are equivalent. A sensory characterization of a sourdough bread may be obtained by a quantitative descriptive analysis method by which a bread is described in terms of its attributes and the intensity of these attributes, for example as follows. Sourdough bread slices, e.g. 1.4 cm thickness, are evaluated by a panel, typically consisting of at least about 10, e.g. 13 trained panelists. The slices are evaluated in individual sensory booths free of odours, noise, or any other distraction. During a formal sensory evaluation, each panelists receives coded slices in monadic sequence and in randomize order. Using a computerized data collection system, panelists score the perceived intensity of each sensory attributes on a continuous line scale of 15 cm (6 inch), anchored 2.5 cm (0.5 inch) from either end. In between samples, panelists are asked to take a mandatory pause of one minute to neutralize their palate by rinsing their mouth with water and eating an unsalted cracker. All samples are presented at room temperature and are evaluated in duplicate.

In an embodiment, the leavening mixture is an intermediate product for preparing a liquid sourdough according to the invention. Such leavening mixture is typically a dough, which has an initial pH (at 20 degrees C.) above 4.5, preferably in the range of 5.5-7.0, more preferably in the range of 5.8-6.5, e.g. about 6.0.

A leavening mixture, in particular a sourdough according to the invention preferably comprises between 10⁷ and 10¹¹ CFU/g LAB, more between 108 and 10¹⁰ CFU/g LAB, more preferably about 10⁹ CFU/g LAB and between 10⁵ and 10⁹ CFU/g yeast, preferably between 10⁶ and 10⁸ CFU/g yeast, more preferably about 10⁷ CFU/g yeast.

The liquid sourdough (prepared) according to the invention preferably has a pH in the range of 3.5 to 4.6, more preferably a pH in the range of 3.9 to 4.2.

The liquid sourdough (prepared) according to the invention preferably has a TTA in the range of 13 to 28, more preferably a TTA in the range of 16 to 25.

The liquid sourdough (prepared) according to the invention preferably has a acetic acid content in the range of 900 to 3200 mg per kilogram of the liquid sourdough, preferably from 1600 to 2800 mg per kilogram of the liquid sourdough, more preferably from 1800 to 2600 mg per kilogram of the liquid sourdough.

The liquid sourdough (prepared) according to the invention preferably has a lactic acid content ranging from 6000 to 20000 mg per kilogram of the liquid sourdough, preferably from 8000 to 18000 mg per kilogram of the liquid sourdough, more preferably from 9500 to 16000 mg per kilogram of the liquid sourdough.

The liquid sourdough (prepared) according to the invention usually has a viscosity at 25° C. of less than 10 000 mPa·s (cP). The viscosity of the liquid sourdough at 25° C. usually is at least 100 mPa·s (at least directly after preparation). The viscosity of the liquid sourdough at 25° C. is preferably in the range of about 2000 to about 9000 mPa·s, more preferably in the range of about 4000 to about 8000 mPa·s. A relatively low viscosity is advantageous with respect to pumpability (during processing) and dosing (by the end-user). As used herein the viscosity is the apparent viscosity as measured by a rotational viscosimeter applying ASTM/ISO 2555 standard (as applicable on 13 Apr. 2024). This kind of viscosimeter is generally known in the art. For instance a LamyRheology Instruments Black One viscosimeter may be used in accordance with its user instructions.

In particular, the following spindle number is used, dependent on the maximum viscosity (Pa·s) value according to speed and ASTM/ISO2555 spindle:

| | Spindle number | | | | | | |
|---|---|---|---|---|---|---|---|
| Speed rpm | Astm1* | Astm2 | Astm3 | Astm4 | Astm5 | Astm6 | Astm7 |
| 250 | 0.56 | 2.22 | 5.56 | 11.12 | 22.26 | 55.65 | 222.6 |
| 200 | 0.69 | 2.78 | 6.95 | 13.91 | 27.82 | 69.55 | 278.2 |
| 100 | 1.39 | 5.56 | 13.91 | 27.82 | 55.65 | 139.1 | 556.5 |
| 60 | 2.31 | 9.27 | 23.18 | 46.36 | 92.75 | 231.8 | 927.5 |
| 50 | 2.78 | 11.13 | 27.82 | 55.65 | 111.3 | 278.2 | 1113 |
| 40 | 3.47 | 13.91 | 34.77 | 69.54 | 139.1 | 347.7 | 1391 |
| 30 | 4.63 | 18.55 | 46.36 | 92.72 | 185.5 | 463.6 | 1855 |
| 20 | 6.95 | 27.82 | 69.55 | 139.1 | 278.2 | 695.5 | 2782 |
| 12 | 11.59 | 46.37 | 115.9 | 231.8 | 493.7 | 1159 | 4937 |
| 10 | 13.91 | 55.65 | 139.1 | 278.2 | 556.5 | 1391 | 5565 |
| 6 | 23.18 | 92.75 | 231.8 | 463.6 | 927.5 | 2318 | 9275 |
| 5 | 27.82 | 111.3 | 278.2 | 556.5 | 1113 | 2782 | 11130 |
| 4 | 34.77 | 139.1 | 347.7 | 695.5 | 1391 | 3477 | 13910 |
| 3 | 46.36 | 185.5 | 463.6 | 927.2 | 1855 | 4636 | 18550 |
| 2.5 | 55.64 | 222.6 | 556.5 | 1112.8 | 2226 | 5565 | 22260 |
| 2 | 69.55 | 278.2 | 695.5 | 1391 | 2782 | 6955 | 27820 |
| 1.5 | 92.73 | 371 | 927.3 | 1854 | 3710 | 9273 | 37100 |
| 1 | 139.1 | 556.5 | 1391 | 2782 | 5565 | 13910 | 55650 |
| 0.6 | 231.8 | 927.5 | 2318 | 4636 | 9275 | 23180 | 92750 |
| 0.5 | 278.2 | 1113 | 2782 | 5565 | 11130 | 76800 | 111300 |
| 0.3 | 463.6 | 1855 | 4636 | 9272 | 18550 | 128000 | 185500 |

A relatively high viscosity generally is the result of a relatively low water content, and thus a relatively high content of active ingredients. Thus, a relatively high viscosity is advantageous in that the liquid sourdough is more concentrated and requires less volume per amount of bakery product that can be made with it.

The liquid sourdough (prepared) in accordance with the invention is particularly suitable for the preparation of a sourdough-leavened bread. The preparation of the bread can be based on known baking methods.

The liquid sourdough (prepared) in accordance with the invention is particularly suitable for the preparation of a sourdough-leavened bread. The preparation of the bread can be based on known baking methods. A sourdough bread can be made by making a bread dough comprising a liquid sourdough and further bread ingredients, and allowing the bread dough to leaven. The bread dough may be fermented in a fermentation cabinet, in a manner known per se, e.g. based on French legislation for the preparation of sourdough leavened bread.

Advantageously, a method for preparing a sourdough-leavened bread according to the invention, comprises mixing of the ingredients for the bread dough (the liquid sourdough and further ingredients for the bread); a first fermentation of a bulk of the bread dough (bulk fermentation); dividing the bulk of bread dough in portions (weighing/rounding); allowing the portions to rest; shaping the portions; a final fermentation of the shaped portions; and baking. The bulk of the bread dough contains sufficient dough for the preparation of a plurality of breads. After the first fermentation, the bulk of the bread dough is portioned in individual portions having a suitable weight for a single bread, thereafter the individual portions are allowed to rest, thereafter the individual portions are each shaped into a bread shape (e.g. using a bread mould), thereafter the shaped bread doughs are subjected to a final fermentation, after which the shaped bread doughs are baked, thereby obtaining the bread. Conditions can be based on known methodology for the separate steps dependent on the desired bread. Bulk fermentation can for example be at a temperature of about 25° C. for about 45 minutes at about 78% moisture. The bread dough may be moulded, e.g. using a baguette moulder. After moulding the bread doughs may be left in a fermentation cabinet with controlled temperature and moisture, which can be based on known baking methods, for example at a temperature of about 25° C. and about 78% moisture. Baking may be performed in an oven, using baking conditions known per se, for instance at a temperature of about 240° C. e.g. for a time period of about 22 min. After the dough has been placed in an oven, vapor may be injected immediately.

The bread made with a liquid sourdough in accordance with the invention preferably has a pH of maximum 4.3. Further, the acetic acid concentration of said bread with a maximum pH of 4.3 preferably is at least 900 ppm (equivalent to 900 mg/kg). Additionally, a sourdough-leavened bread according to the invention may comprise between 0.05% and 0.35%, preferably between 0.1% and 0.3%, more preferably between 0.15% and 0.25%, such as about 0.2%, of Saccharomyces cerevisiae relative to the weight of flour in the sourdough.

For the purpose of clarity and a concise description, features are described herein as part of the same or separate aspects and preferred embodiments thereof, however, it will be appreciated that the scope of the invention may include embodiments having combinations of all or some of the features described.

### Example 1: Role of Inactive Yeast

### Materials and Methods

All ingredients as provided in table 1 except of starters were added into a fermenter. Ingredients were not added at once. When all ingredients were mixed and the slurry was at fermentation temperature, the LAB and yeast starters were added. All ingredients were provided by AB Mauri, with exception of water.

The fermentation reaction was performed for 48 hours at 30° C. (see Table 1). Hereafter, the sourdough was cooled to 5° C. for a period of 2 hours. After the cooling step, dry or compressed yeast was added at 5% of total sourdough volume. To prevent lumps, the yeast was mixed with water in an amount equal to solids content of the yeast before addition to the fermenter.

Sourdoughs were collected and stored in jerry cans with vented lids to allow for gas exchange and prevent swelling of containers.

TABLE 1

| | Amount (g) | |
|---|---|---|
| Ingredients (source) | | |
| Wheat flour (Dossche Mills, Rotterdam, Netherlands) | 90 | |
| Wheat bran (fine milled) (Dossche Mills, Rotterdam, | 5 | |
| Netherlands) | | |
| Inactive yeast (S. cerevisiae) | 5 | |
| Active malted wheat flour (AIT ingredients, | 0.5 | |
| Corbeil-Essones, France) | | |
| Active starter yeast - L. thermotolerans (Mauri Technology, | 0.04 | |
| Etten-Leur, Netherlands) | | |
| Active starter LAB - L. brevis (Mauri Technology, | 10 | |
| Etten-Leur, Netherlands) | | |
| Water | 110 | |
| Process parameters | | |
| Fermentation time | 48 | h |
| Fermentation temperature | 30° | C. |
| Cooling time | 2 | h |
| Cooling temperature | 5° | C. |

After fermentation, sourdoughs were stored in a fridge at 5° C. for 12 weeks. Every week until week 12, samples were collected to determine TTA, pH, cell counts, organic acid content and sugar content.

For the determination of lactic acid bacteria (LAB) and yeast cell counts, 1 g of sourdough was diluted with 9 mL of Ringers solution (Sigma-Aldrich, St. Louise, MO, USA). Cell counts were determined by plating serial dilution of sourdough samples on MRS (Carl Roth, Karlsruhe, Germany) with 50 mg/L of cycloheximide (Sigma-Aldrich, St. Louise, MO, USA) and YPD agar (Sigma-Aldrich, St. Louise, MO, USA) with 30 mg/L of chloramphenicol (Sigma-Aldrich, St. Louise, MO, USA). The MRS plates were incubated anaerobically at 37° C. for 48 h and the YPD plates were incubated aerobically at 30° C. for 48 h.

For the determination of total titrable acidity (TTA) and pH, a Titroline 6000 with autosampler (SI Analytics, Mainz, Germany) was used. 5 g of sourdoughs were suspended in 100 mL of distilled water and the suspension was homogenized using Ultra Turrax T18 Digital (IKA-Werke, Staufen, Germany). The resulting aliquots were titrated with 0.1 M NaOH using Titroline 6000 titrator until the pH reached 8.5. Experiments were run in duplicate and TTA was calculated by dividing 10 by the sample weight (g), and multiplying the obtained value by the NaOH content (ml).

Organic acids and sugars were quantified by suspension of 2 g of sourdough in 20 mL of Milli-Q water. The suspension was shaken on the shaking table at 150 rpm for 30 min and thereafter centrifuged at 4000 rpm for 15 min. The supernatants were filtered directly (0.22 μm) in a HPLC vial. The samples were kept in the freezer until they were ready to use. The quantification of compounds was performed by using high performance liquid chromatography (HPLC) with Agilent Hi-Plex H (4.7×300 mm). The eluent was 0.1% TFA in Milli-Q water and the column temperature was 40° C. The injection volume of each sample was 5 μL and the flow rate was 0.6 mL/min. Organic acids were detected with a VWD detector at 210 nm and sugars were detected with a refractive index (RID) detector.

### Results

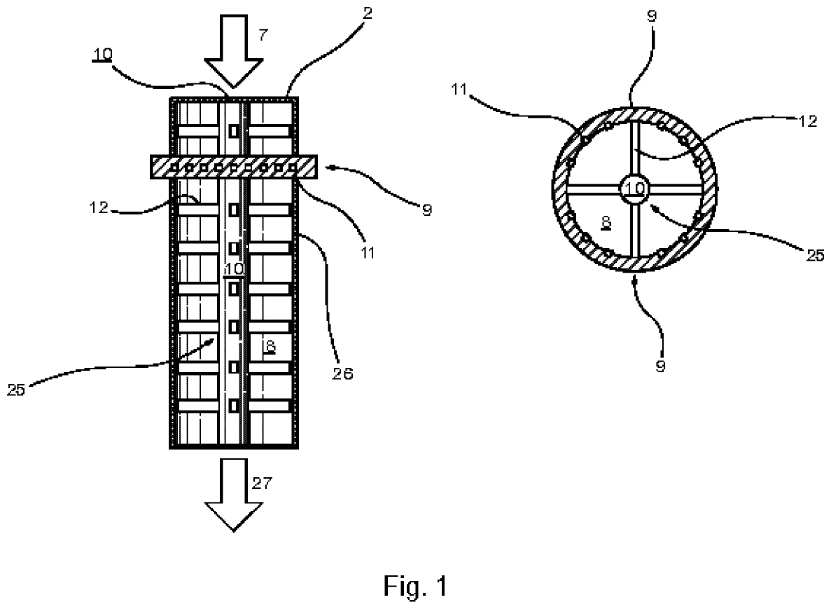

A liquid leavening mixture comprising inactive yeasts was compared to a liquid leavening mixture not comprising inactive yeasts. In the sourdough obtained by using a leavening mixture comprising inactive yeasts, there was no significant decrease in CFU/g of either bacteria or yeast observed, while this was observed in the sourdough obtained by using a leavening mixture not comprising inactive yeasts (see FIG. 1).

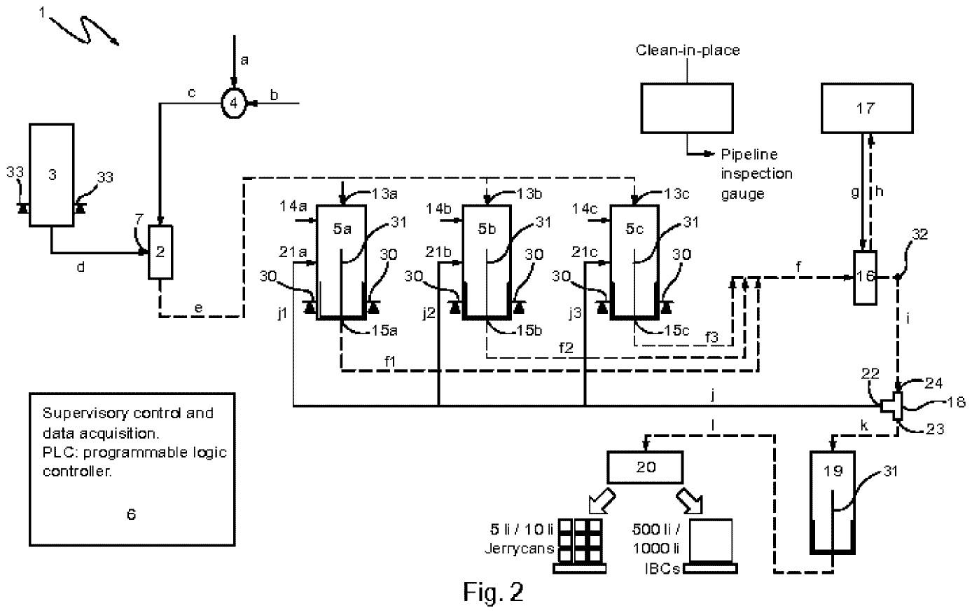

Furthermore, the total titratable acidity (TTA) of sourdough made with inactive yeast was higher and more stable throughout the shelf life of the sourdough compared to a sourdough made without inactive yeast (see FIG. 2). This allows the baker to use a lower dosage in baking to achieve the same acidity flavor notes. In sourdough with no added inactive yeast, there was a steady rise in TTA over the shelf life period, contributing to the drop in yeast and bacteria viability seen in FIG. 1A. The fact that the pH did not significantly differ between a sourdough made with or without inactive yeast may be explained by the buffering capacity of the minerals and proteins present in the bran and inactive yeasts.

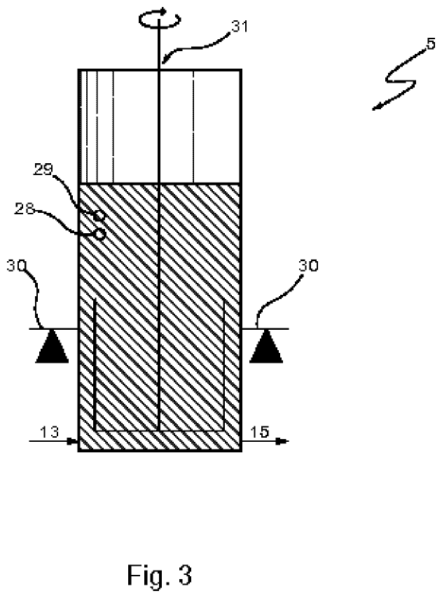

Further, the acid concentration (i.e. acetic acid and lactic acid) showed a more stable trend throughout the shelf life of the sourdough made with inactive yeast compared to a sourdough made without inactive yeast. There was a slightly higher acetic acid content and lower lactic acid content at the start of shelf-life testing, and these levels stay much the same throughout (see FIG. 3B). In the sourdough with no added inactive yeast a sharp increase in acids was observed at the start of the shelf life testing (see FIG. 3A). This would result in a product that is not consistent in quality.

### Example 2

Liquid sourdoughs are prepared using an installation according to the invention. The ingredients are from the same source as listed as in table 1, except for the fructose. However, ingredient concentrations were varied, as indicated in table 2 below.

TABLE 2

| | | | | | Ingredients | | | | | | | | |
|---|---|---|---|---|---|---|---|---|---|---|---|---|---|
| | | Dough | | | | Inactive | Active | Fruc- | LAB | Yeast | Yeast | Xan- | Sodium |
| | Date | Yield | Water | Flour | Bran | yeast | malt | tose | starter | starter | pitch | than | diacetate |
| | | | grams | | | | | | | | | | |
| Example 1 | Feb-22 | 200 | 110 | 90 | 5 | 5 | 0.5 | 0 | 10 | 0.001 | 5 | 0 | 0 |
| | | | % of total sourdough volume | | | | | | | | | | |
| LactosanBrevis_001 | 2024 Jan. 31 | 285 | 65 | 27.825 | 1.75 | 0 | 0.175 | 0 | 0.001 | 0.001 | 0 | 0.8 | 0 |
| F20_001 | 2024 Feb. 26 | 285 | 65 | 31.5 | 1.75 | 1.75 | 0 | 0 | 3.5 | 0.001 | 5 - dry | 0.8 | 0.6 |
| | | | | | | | | | | | and fresh | | |
| F20_002 | 2024 Mar. 4 | 285 | 65 | 34.825 | 1.75 | 0 | 0 | 0 | 3.5 | 0.001 | 5 | 0.8 | 0.6 |
| Acetic_001 | 2024 Apr. 4 | 285 | 65 | 33.075 | 1.75 | 0 | 0.175 | 3 | 0.001 | 0.001 | 5 | 0.8 | 0.6 |
| Acetic_002 | 2024 Apr. 8 | 285 | 65 | 34.825 | 1.75 | 0 | 0 | 3 | 0.001 | 0.001 | 5 | 0.8 | 0.6 |

Properties of these liquid sourdoughs, such as stability of the living yeast and lactic acid bacteria, TTA, acid concentration (lactic acid and acetic acid) are compared with a corresponding liquid sourdough, comprising flour, flour bran, water, active malt flour, at least one inactive yeast, at least one active lactic acid producing starter bacterium, at least one active starter yeast and optionally fructose.

### LEGEND TO FIGURES

1) Liquid-sourdough production installation
2) flour hydration unit
3) flour dosing system
4) (warm) water dosing system
5) fermenter (5a, 5b, 5c)
6) automated process control system
7) flour feed inlet
8) flour hydration chamber
9) water distributor
10) agitator, such as a central vertical shaft (25) having a plurality of arms (12) extending essentially perpendicular with respect to the shaft
11) spray nozzles
12) rotatable arms of agitator 10
13) Dough inlet (13a, 13b, 13c) into the fermenter 5
14) Provision (14a, 14b, 14c) for further ingredient, such as liquid yeast preparation into the liquid sourdough
15) Outlet (15a, 15b, 15c) for liquid sourdough from fermenter
16) Heat exchanger for cooling liquid sourdough
17) Coolant supply for heat exchanger 16
18) Liquid sourdough flow director (3-way valve)
19) Storage for liquid sourdough
20) Packaging unit for packing liquid sourdough
21) Inlet for recycled liquid sourdough into the fermenter (21a, 21b, 21c)
22) Outlet for recycle from flow director 18 to fermenter
23) Outlet of flow director for liquid sourdough to be stored/packaged
24) Inlet for cooled liquid sourdough into flow director 18
25) Rotatable shaft of agitator 10
26) Side wall of flour hydration chamber
27) Dough outlet from hydration chamber
28) Temperature sensor in fermenter
29) pH sensor in fermenter
30) weight sensor in fermenter
31) Fermenter stirrer
32) Temperature sensor for cooled liquid sourdough
33) Weight sensor of flour dosing system

### CONDUITS/STREAMS

a) hot water
b) cold water
c) water supply to flour hydration chamber 8
d) flour (mixture) supply to flour hydration chamber 8
e) (pumpable) dough to fermenter 5
f) liquid sourdough to heat exchanger 16
g) cooling medium to heat exchanger 16
h) used cooling medium from heat exchanger 16
i) cooled liquid sourdough to flow director 18
j) recycle of cooled liquid sourdough to fermenter (j1, j2, j3)
k) cooled liquid sourdough to storage 19
l) liquid sourdough from storage 19 to packing unit 20.

1. Liquid-sourdough manufacturing installation, comprising
a flour hydration unit, comprising a flour hydration chamber;
a flour dosing system;
a water dosing system; and
a fermenter;
wherein the flour hydration unit comprises a flour feed inlet into an upper part of the flour hydration chamber, the flour hydration chamber comprising a water distributor in an upper part of the flour hydration chamber, which water distributor is configured to receive water from the water dosing system and which water distributor is arranged to distribute atomized water in the flour hydration chamber, the flour hydration chamber further containing an agitator arranged to blend the contents of the flour hydration chamber, the flour hydration chamber further comprising an outlet for dough formed in the hydration chamber;
wherein the outlet for dough is connected with a dough inlet of the fermenter via a conduit for feeding the dough from the flour hydration chamber to the fermenter; and
wherein the fermenter further comprises an outlet for liquid sourdough.

2. Liquid-sourdough manufacturing installation according to claim 1, wherein the installation comprises an automated process control system, adapted to control an operation of the installation.

3. Liquid-sourdough manufacturing installation according to claim 2, wherein the automated process control system comprises a programable logic controller (PLC) adapted for supervisory control and data acquisition (SCADA).

4. Liquid-sourdough manufacturing installation according to claim 2, wherein the process control system is adapted to control the temperature of water supplied to the water distributor, to control the flow rate of the water supplied to the water distributor and to control the mass flow rate of flour or the mass flow rate of a mixture of flour plus one or more other ingredients supplied to the flour hydration chamber.

5. Liquid-sourdough manufacturing installation according to claim 2, wherein
the fermenter contains a temperature sensor for measuring the temperature of the fermenter contents and the automated process control system is adapted for controlling the temperature of the fermenter contents;
the fermenter contains a pH sensor for measuring the temperature of the fermenter contents and the automated process control system is adapted for monitoring the pH of the fermenter contents;
the fermenter contains a weight sensor for measuring the weight of the fermenter contents and the automated process control system is adapted for controlling the weight of the fermenter contents; and
the fermenter contains a stirrer which is controlled by the automated process control system.

6. Liquid-sourdough manufacturing installation according to claim 1, wherein the water dosing system has a hot water inlet and a cold water inlet and the water dosing system is configured to mix hot water from the hot water inlet and cold water from the cold water inlet to provide warm water having a pre-set temperature.

7. Liquid-sourdough manufacturing installation according to claim 1, wherein the installation comprises a heat exchanger for cooling liquid sourdough fed into the heat exchanger from the outlet of the fermenter via a conduit for liquid sourdough.

8. Liquid-sourdough manufacturing installation according to claim 7, the installation further comprising a controllable flow director, comprising
an inlet for cooled liquid sourdough received from the heat exchanger via a cooled liquid sourdough conduit;
a recycle stream outlet for cooled liquid sourdough, connected with a recycle stream inlet into the fermenter via a recycle stream conduit; and
a product stream outlet for cooled liquid sourdough, connected to a further unit, such as a storage unit or a packing unit, via a product stream conduit.

9. Liquid-sourdough manufacturing installation according to claim 8, wherein the installation comprises a temperature sensor adapted for measuring the temperature of the cooled liquid sourdough, which sensor can be present at the outlet of the heat exchanger, at the inlet of the flow director, in the flow director or in a conduit between heat exchanger and the flow director; and wherein the flow director is controllable by the automated process control system, which process control system is adapted to adjust the flow rates of cooled liquid sourdough through product outlet and through recycle outlet on the basis of temperature data provided by said temperature sensor adapted for measuring the temperature of the cooled liquid sourdough.

10. Liquid-sourdough manufacturing installation according to claim 9, wherein the process control system and the flow director are adapted to close the product outlet and to open the recycle outlet if the temperature is above a set-point temperature, between 0 and 10 degrees C., and wherein the process control system and the flow director are adapted to open the product outlet and to close the recycle outlet if the temperature is at or below said set-point temperature.

11. Liquid-sourdough manufacturing installation according to claim 1, wherein the installation is a fully automated clean-in-place (CIP) installation, and wherein the installation is provided with a pipeline inspection gauge (PIG).

12. Liquid-sourdough manufacturing installation according to claim 1, wherein the installation comprises a provision configured for introducing a liquid yeast preparation into liquid sourdough produced in the fermenter, which provision is present in the fermenter or downstream of the fermenter.

13. Liquid-sourdough manufacturing installation according to claim 1, wherein the agitator extends at least substantially along the flour hydration chamber, the agitator comprising an essentially vertically positioned rotatable central shaft and a plurality of arms extending essentially perpendicular with respect to the shaft.

14. Liquid-sourdough manufacturing installation according to claim 1, wherein the water distributor comprises a plurality of spray nozzles at or near the side wall an in upper part of the flour hydration chamber, which spray nozzles are arranged to spray atomized water inward into the hydration chamber in an at least substantially perpendicular to the flow path between the flour feed inlet and the pumpable dough outlet.

15. Liquid-sourdough manufacturing installation according to claim 1, wherein the flour dosing system comprises a loss-in-weight feeder.

16-19. (canceled)

20. Method for the production of a liquid sourdough using an installation according to claim 1, comprising
hydrating cereal flour or a mixture comprising cereal flour and one or more other ingredients, in the flour hydration chamber under formation of the dough,
feeding the dough via a conduit, from the hydration chamber to the fermenter,
subjecting the dough to fermentation in the fermenter under formation of the liquid sourdough, and discharging the liquid sourdough from the fermenter.

21. Method according to claim 20, wherein the mixture comprising cereal flour further comprises active malt flour, at least one inactive yeast, at least one active lactic acid producing starter bacterium, at least one active starter yeast and water.

22. Method according to claim 20, wherein the dough that is to be subjected to the fermentation in the fermenter comprises active malt flour, at least one inactive yeast, at least one active lactic acid producing starter bacterium, at least one active starter yeast and water.

23. Method according to claim 20, wherein the dough that is to be subjected to the fermentation in the fermenter has a flour content in the range of 20-45 wt. %.

24. Method according to claim 20, wherein the dough that is to be subjected to the fermentation in the fermenter has a cereal bran content in the range of 0.5-3 wt. %.

25. Method according to claim 20, wherein the dough that is to be subjected to the fermentation in the fermenter has an active malt flour content in the range of 0.1-1 wt. %.

26. Method according to claim 20, wherein the dough that is to be subjected to the fermentation in the fermenter has an inactive yeast content of at least 1 wt. %.

27. Method according to claim 20, wherein the dough that is to be subjected to the fermentation in the fermenter has an active yeast starter content of at least 0.005 wt. %.

28. Method according to claim 20, wherein the dough that is to be subjected to the fermentation in the fermenter has a lactic acid producing starter bacteria content in the range of 0.005-5 wt. %.

29. Method according to claim 20, wherein the dough that is to be subjected to the fermentation in the fermenter has a water content in the range of 60-75 wt. % and a cereal flour content of 20-37 wt. %.

30. (canceled)

31. Method according to claim 20, wherein a liquid sourdough is prepared having a lactic acid bacteria content in the range of 0.001-2 wt. %.

32. Method according to claim 20, wherein the dough that is to be subjected to the fermentation in the fermenter has a water content in the range of 40-60 wt. % and a cereal flour content of 37-45 wt. %.

33. Method according claim 32, wherein a liquid sourdough is prepared, having a lactic acid bacteria content in the range of 0.001-1 wt. %, in the range of 1-4 wt. % or in the range of 4-5 wt. %.

34. Method according to claim 20, wherein the dough that is to be subjected to the fermentation in the fermenter has a fructose content in in the range of 0.5-5 wt. %.

35. Liquid sourdough, obtained by a method according to claim 20 or made from a dough as defined in claim 20.
